(19) United States
(12) Patent Application Publication
(10) Pub. No.: US 2012/0032808 A1
(43) Pub. Date: Feb. 9, 2012

(54) CONNECTOR FOR PATIENT MONITORING DEVICE

(75) Inventor: Julian H. Cherubini, Boston, MA (US)

(73) Assignee: AliMed, Inc., Dedham, MA (US)

(21) Appl. No.: 12/850,165

(22) Filed: Aug. 4, 2010

(51) Int. Cl. G08B 23/00

(52) U.S. Cl. 340/573.4

(57) ABSTRACT

A patient monitoring device for use with a patient and a caregiver is provided. The patient monitoring device may include a warning system configured to provide an alarm to indicate, to a caregiver, a change in the position of a patient and a flexible tether extending outwardly from the warning system. The monitoring device may include a clip configured to be removably coupled to the tether and removably coupled to the patient, where the warning system is configured to activate the alarm when the clip is decoupled from the tether.

### FIELD OF INVENTION

This invention relates generally to a patient monitoring device and in particular to a patient monitoring device which produces an alarm to alert a caregiver when the patient moves into an undesirable position.

### BACKGROUND OF INVENTION

In a variety of settings, such as in hospitals, hospices, nursing homes, home care, and other types of health care institutions, patients are monitored, often continuously, by doctors, nurses, and other support staff. In many circumstances, it may be impractical for one caregiver to monitor only one patient. It is more common, for example, in a nursing home, for a nurse to be assigned to care for and monitor 10 to 20 patients.

Various types of patient monitoring devices are known to assist a caregiver when the caregiver is monitoring more than one patient at a time. These types of monitoring devices may alert the caregiver when a particular patient may require the caregiver's immediate attention. For example, a patient monitoring device may include a pressure sensor and will alert a caregiver with a warning sound if a patient falls and/or moves away from the pressure sensor.

Another type of patient monitoring device, known as a pull cord alarm, mechanically couples a patient (or the patient's clothing) to an alarm that will alert a caregiver if the patient is decoupled from the alarm. For example, one type of pull cord alarm monitoring device 10 is illustrated in FIGS. 1-2. The monitoring device 10 includes a clip 30 coupled to a warning system 20 through a cord 32. As shown in FIG. 2, the cord 32 includes a male end/plug 34 which is inserted into a female end/receptacle 36 in the warning system 20 to couple the cord 32 directly to the warning system 20. The clip 30 is configured to be coupled to a patient, for example, by directly attaching to the patient's clothing. When the patient moves away from the warning system 20, the male end 34 of the cord 32 pulls out of the warning system 20, thus decoupling the patient from the warning system 20 and activating an alarm.

Another type of pull cord alarm monitoring device is illustrated in FIG. 3. This monitoring device 40 similarly includes a clip 30 coupled to a warning system 20 through a cord 32. Instead of a male/female attachment of the cord 32 directly to the warning system 20, the cord 32 is magnetically coupled to the warning system. For example, the end of the cord 32 may include a magnet 38 which is attracted to a magnet (not shown) associated with the warning system 20. When a patient moves away from the warning system, the cord 32 and magnet 38 pull away from the warning system 20, thus decoupling the patient from the warning system and activating an alarm.

### SUMMARY OF INVENTION

In one aspect, a patient monitoring device for use with a patient and a caregiver is disclosed. The monitoring device includes a warning system configured to provide an alarm to indicate, to a caregiver, a change in the position of a patient, a tether extending outwardly from the warning system, and a clip configured to be removably coupled to the tether and removably coupled to the patient, where the warning system is configured to activate the alarm when the clip is decoupled from the tether.

In another aspect, a patient monitoring device for use with a patient and a caregiver is disclosed. The monitoring device includes a warning system configured to provide an alarm to indicate, to a caregiver, a change in the position of a patient, a clip configured to be non-magnetically removably coupled to the warning system and removably coupled to the patient, where the warning system is configured to activate the alarm when the clip is decoupled from the warning system. The clip is flexibly connected to the warning system such that the clip may be decoupled from the warning system at a pull angle range of at least approximately 180 degrees.

In yet another aspect, a method of monitoring a patient by a caregiver is disclosed. The method includes attaching a clip of a patient monitoring device to a patient, where the patient monitoring device includes a warning system configured to provide an alarm, a tether extending outwardly from the warning system, and a clip configured to be removably coupled to the tether, and activating the alarm when the clip is decoupled from the tether.

In yet another further aspect, a patient monitoring device for use with a patient and a caregiver is disclosed. The monitoring device includes a warning system configured to provide an alarm to indicate, to a caregiver, a change in the position of a patient, and a first tether extending outwardly from the warning system at one end and being configured to be attached to a patient at another end, the first tether having associated therewith a first receptacle into which a first plug is inserted, the first plug being pulled from the first receptacle when a certain force is applied thereto resulting from patient movement, to activate the warning system with a first alarm. The monitoring device further includes a second tether extending outwardly from the warning system at one end and being configured to be attached to the patient at another end. Associated with the second tether is a second receptacle into which a second plug is inserted. The second plug is pulled from the second receptacle only after the first plug is pulled from the first receptacle upon continued movement of the patient to activate the warning system with a second alarm. In one embodiment, a first clip is provided which is configured to be removably coupled to the patient and to one of the first receptacle and the first plug. A second clip may also be provided and is configured to be removably coupled to the patient and one of the second plug and second receptacle. In another embodiment, one of the second plug and second receptacle is configured to be coupled to the first clip. In yet another embodiment, the second tether is longer than the first tether. In another further embodiment, the second plug requires a force to be pulled from the second receptacle that is greater than the force required to pull the first plug from the first receptacle. In yet another embodiment, when the first plug is pulled from the first receptacle, a light is activated for illuminating an area around the patient.

Various embodiments provide certain advantages. Not all embodiments share the same advantages and those that do may not share them under all circumstances.

Further features and advantages, as well as the structure of various embodiments that incorporate aspects are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like descriptor. For purposes of clarity, not every component may be labeled in every drawing.

Various embodiments will now be described, by way of example, with reference to the accompanying drawings, in which:

FIG. 1 is a perspective view of a prior art patient monitoring device;

FIG. 2 is a side view of a portion of the prior art patient monitoring device shown in FIG. 1;

FIG. 3 is a perspective view of another prior art patient monitoring device;

FIG. 4 is a perspective view of a patient monitoring device according to one embodiment;

FIG. 5 is a side view of a patient monitoring device according to one embodiment;

FIG. 6 is a perspective view of another embodiment of a patient monitoring device;

FIG. 7 is a perspective view of yet another embodiment of a patient monitoring device;

FIG. 8 is a perspective view of a patient monitoring device according to yet another embodiment; and

FIG. 9 is a perspective view of a patient monitoring device according to yet another further embodiment.

### DETAILED DESCRIPTION

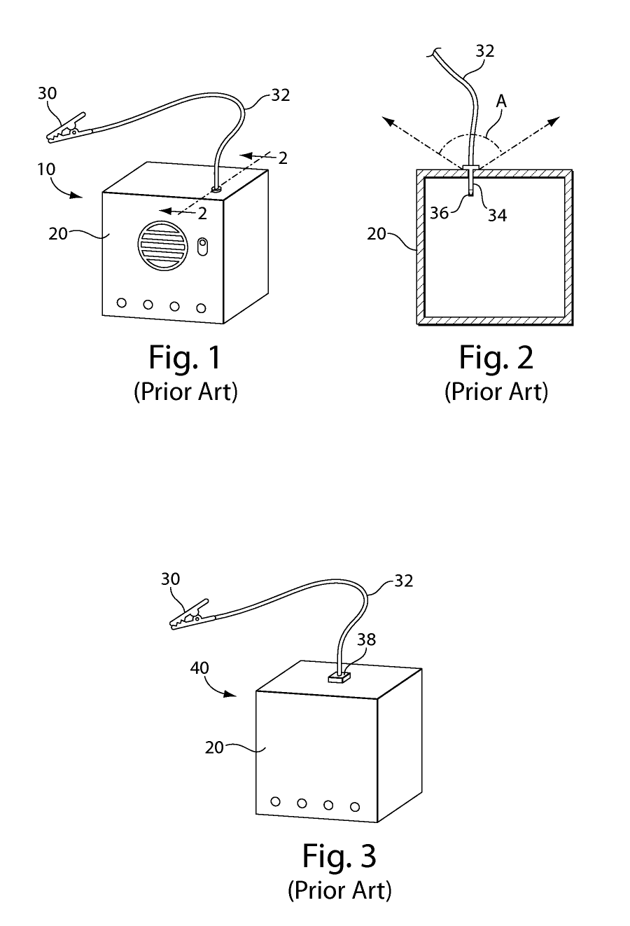

Applicant recognized that there are some drawbacks associated with some of the above-mentioned pull cord patient monitoring devices. For example, with the monitoring device 10 shown in FIGS. 1-2, the angle of the pull cord 32 relative to the warning system 20 may affect whether the cord 32 pulls out from the warning system 20 and activates an alarm. In particular, Applicant recognized that when the cord 32 is pulled at an angle that is approximately parallel to the male plug 34 (i.e. when the cord is substantially perpendicular to the top plane of the warning system 20 shown in FIG. 2), the male plug 34 may more easily pull out of the female receptacle 36 decoupling the patient from the warning system and activating an alarm. However, as the angle of the cord 32 is varied, the amount of force needed to pull the cord 32 out of the warning system 20 may increase. Applicant recognized that the cord 32 cannot be pulled out of the warning system when the cord is substantially parallel to the top plane of the warning system. Applicant determined that for a pull cord patient monitoring device having a male plug 34 attachment to the warning system 20, the cord 32 has an effective pull angle range A (see FIG. 2), which, with one particular type of monitoring device, is approximately 90°. When the cord 32 is oriented outside of the effective pull angle range, for example, due to the position of the patient, it may be more difficult to decouple the cord from the warning system. This may lead to undesirable results such as pulling or tension on the patient as the patient moves away from the warning system, decoupling of the clip from the patient which may not cause the alarm activate, and/or pulling and even dragging of the warning system in the direction of the patient.

Applicant recognized that there are also drawbacks associated with a magnetic pull cord patient monitoring devices, such as that disclosed above and shown in FIG. 3. For example, there are various circumstances where magnets are undesirable and/or cannot be used, such as, but not limited to in a cardiac intensive care unit because the magnets may affect devices, such as pacemakers.

Thus, aspects of the present invention are directed to pull cord patient monitoring devices that do not suffer from some of the above-mentioned drawbacks. In particular, as discussed in greater detail below, a pull cord patient monitoring device is provided that has a wider effective pull angle range. For example, in one embodiment, a patient monitoring device is provided that has an effective pull range angle of at least 180°. In this respect, the monitoring device is configured such that the clip/cord may be decoupled from the warning system when the clip/cord is substantially parallel to the surface of the enclosure for the warning system to which the cord is coupled, or even if the clip/cord drops below the surface of the enclosure for the warning system to which it is coupled to form an angle of greater than 180 degrees with respect to that surface. Typically, the cord is made of a flexible material, although it need not be. Furthermore, as discussed below, a non-magnetic patient monitoring device is provided.

As set forth below, the present invention is directed to a patient monitoring device that has a warning system which is configured to provide an alarm if a patient moves outside of a defined area. The monitoring device includes at least one clip which is configured to be removably coupled to the patient and the warning system is configured to activate the alarm when the clip is decoupled from the warning system. In this respect, the monitoring device activates an alarm to alert a caregiver if the position or location of the patient deviates undesirably.

In one aspect, the present invention is directed to a patient monitoring device for less critical types of patient monitoring. In one embodiment, the patient monitoring device detects when a patient is slouching in his/her seat. The patient monitoring device may also be employed to detect sacral sitting or forward sliding, which are common problems with a patient sitting in a wheelchair. In another embodiment, the monitoring device detects when a patient may be about to slide or fall out of his/her chair or bed. In yet other embodiments, the monitoring device detects when a patient has wandered away from his/her bed or chair. The patient monitoring device may be used to detect a variety of different types of changes in the patient's position and/or location depending upon the particular desired application.

It should be appreciated that the term “patient” refers to anyone who may be monitored, and may include for example people in either outpatient and inpatient care, as well as people being treated at nursing homes, hospitals, doctor's offices, etc. It should be recognized that a “patient” may also be used to describe a person in a home care setting. Furthermore, the term “caregiver” may refer to anyone who is monitoring a patient. A representative but not limiting list of types of caregivers includes doctors, nurses, hospital or nursing home support staff, and home caregivers.

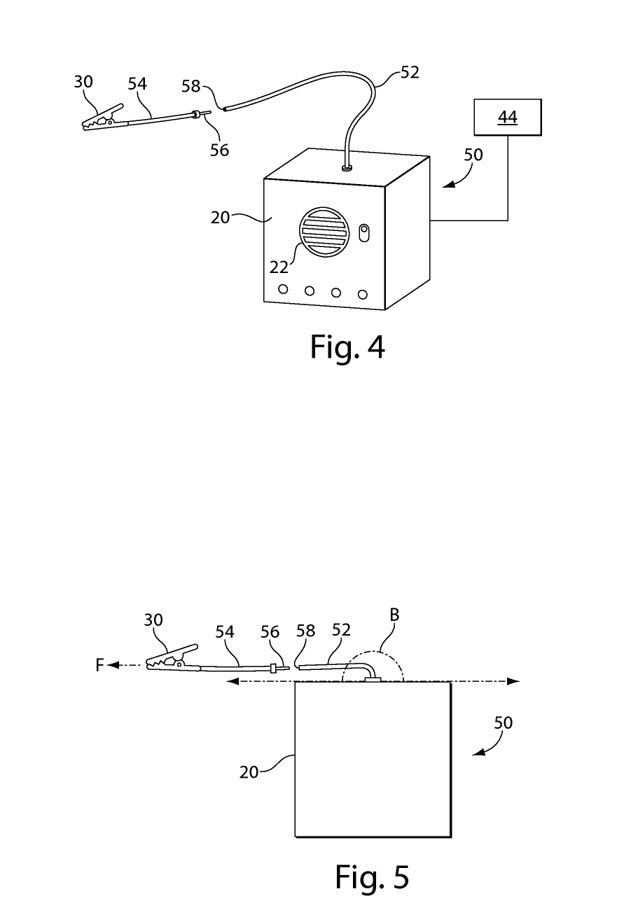

FIG. 4 illustrates one embodiment of a pull cord patient monitoring device 50 according to the present invention. In this embodiment, monitoring device 50 has a clip 30 or a similar device that is configured to be coupled to a patient, for example, by directly attaching to the patient's clothing, and a warning system 20 that is configured to provide an alarm to indicate a change in the position of the patient. The monitoring device 50 further includes a tether 52 coupled to and extending outwardly from a surface or wall of the warning system 50. Warning system 50 may include a top wall 24 and side walls 26. In the embodiment of FIG. 4, tether 52 extends from top wall 24. The clip is configured to be removably coupled to the tether 52 and the warning system is configured to activate the alarm when clip 30 is decoupled from tether 52. FIG. 4 illustrates one embodiment where clip 30 is decoupled from tether 52.

Clip 30 may be removably coupled to tether 52 in a variety of ways as the invention is not limited in this respect. In one illustrative embodiment, a cord 54 extends out from clip 30 and clip 30 is removably coupled to tether 52 through the cord 54. In one particular embodiment, the end of cord 54 includes a male end/plug 56 and the end of tether 52 includes a female end/receptacle 58 which is configured to receive plug 56 to removably couple clip 30 to tether 52. It should be appreciated that in another embodiment, the male end of the removable connection may be located on the tether and the mating female end may be located on the clip or cord as the invention is not so limited. Furthermore, the invention also contemplates other types of mechanical couplings such as, but not limited to various hook and loop fasteners, such as VELCRO®, snaps, buckles and the like. As shown, when the patient moves away from warning system 20, end 56 of cord 54 pulls out of receptacle 58 in tether 52, thus decoupling the patient from warning system 20 and activating an alarm.

As illustrated in FIG. 5, in one embodiment, tether 52 is configured such that clip 30 may be decoupled from the warning system 20 at a pull angle range B of at least approximately 180 degrees, and in some embodiments at a pull angle B of greater than 180 degrees. Pull angle B is the angle tether 52 forms with respect to the surface of system 20 to which tether 52 is coupled when a pull force is applied to tether 52. As mentioned above and as illustrated in FIG. 2, one of the drawbacks associated with some of the prior art pull cord patient monitoring devices is that because male plug 34 is inserted directly into a surface of warning system 20, cord 32 has an effective pull angle range A with respect to that surface (see FIG. 2), in one particular type of monitoring device, of only approximately 90°. When cord 32 is oriented with respect to that surface outside of the effective pull angle range, it may be more difficult to decouple the cord from the warning system.

Applicant recognized that by incorporating tether 52 into the warning system 20, a patient monitoring device is provided which has a wider effective pull angle range B.

In this respect, the position of the patient, and thus the orientation of clip 30, cord 54, and/or tether 52 may not undesirably affect the amount of force needed to decouple the clip from the warning system. As shown in FIG. 5, in one embodiment, a patient monitoring device is provided where the clip is flexibly connected to the warning system such that the clip may be decoupled from the warning system with a pull range angle B of at least approximately 180°. As shown in FIG. 5, this angle B may extend out at one end in a first direction substantially parallel to the surface of the warning system to which the tether is attached, and at the other end of the pull range angle B in a second direction that is opposite of the first direction. In this respect, the monitoring device is configured such that the clip/cord may be decoupled from the warning system when the clip/cord is substantially parallel to the surface of the warning system to which the tether is attached in multiple directions. It is also contemplated that the patient monitoring device may be configured such that the clip/cord may be decoupled from the warning system when the clip/cord is positioned below or behind an imaginary surface extending from and substantially parallel to the surface of the warning system to which the tether is attached, such as a plane extending from and substantially parallel to surface 24. In one embodiment, a patient monitoring device is provided where the clip is flexibly connected to the warning system such that the clip may be decoupled from the warning system with a pull range angle B of at least approximately 360°. In such an embodiment, the clip/cord may be moved into a wide variety of orientations relative to the surface of the warning system to which the tether is attached while still being capable of decoupling from the warning system to activate the alarm.

The configuration of tether 52 may vary as the invention is not limited in this respect. In one embodiment, tether 52 is made from a flexible material. For example, tether 52 may be sufficiently flexible to allow it to flex or bend to be parallel to surface 24 or even to allow it to bend around the edges of surface 24 so that clip 30 is disposed below a plane extending from and substantially parallel to surface 24. In another embodiment, tether 52 may be made from materials such as, but not limited to, a wire coated with an insulating material, such as a plastic material. In another embodiment, tether 52 is made from a substantially rigid material, such as, but not limited to a metal or plastic tube. When tether 52 is made from a substantially rigid material, it is contemplated that there may be one or more swivel joints either as part of tether 52 and/or at one of the ends of tether 52 to enable tether 52 to flexible connect the clip to the warning system.

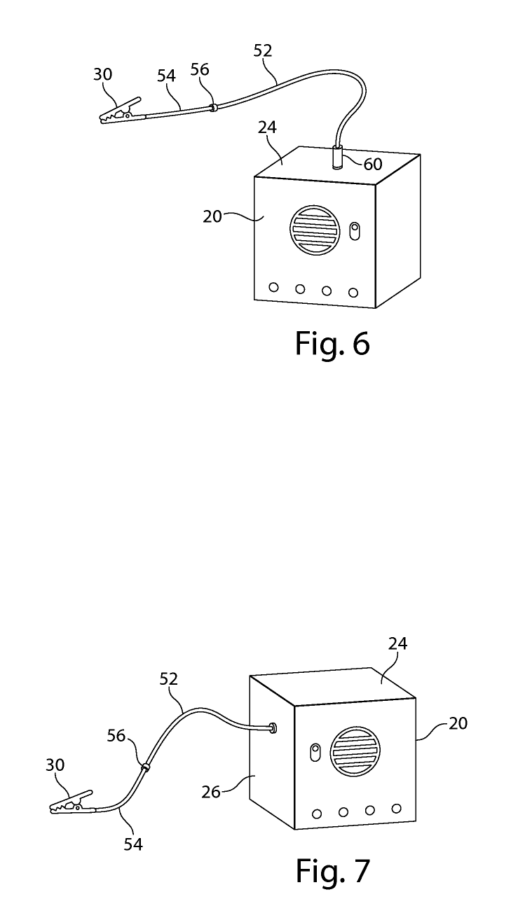

It is contemplated that the stiffness of tether 52 may be substantially uniform throughout the length of tether 52. It is also contemplated that the stiffness of tether 52 may vary across the length of tether 52, for example, by varying the cross-sectional thickness and/or varying the material. As shown in FIG. 6, it is also contemplated that a sleeve 60 may be placed over all or portions of tether 52 to vary the stiffness of tether 52.

The length of tether 52 may also vary according to various embodiments of the present invention. For example, in one embodiment, tether 52 may be approximately 2-6 inches in length, whereas in another embodiment, tether 52 may be at least approximately 1 foot in length, at least approximately 2 feet in length, at least approximately 3 feet in length, and at least approximately 4 feet in length. In one embodiment, the length of the tether is adjustable so that the caregiver may adjust the length of tether 52 based upon the patient and/or the particular patient setting. For example, if the patient is sitting on a chair, the length of tether 52 may be adjusted to enable to patient to be able to lean forward and/or back and shift his/her weight around in the chair without activating the alarm. In another embodiment, the length of tether 52 may be adjusted to allow the patient to stand up and/or walk around the warning system without activating the alarm.

In one embodiment, tether 52 includes a channel therethrough. As shown in FIG. 4, in one embodiment, the channel may form receptacle 58 which is configured to receive plug 56. The channel through tether 52 may also include one or more components which enable warning system 20 to detect when plug 56 (and thus clip 30) is decoupled from receptacle 58. For example, there may be a mechanical or electrical switch which is configured to activate the alarm in warning system 20 when plug 56 is decoupled from receptacle 58. Thus, it is contemplated that one or more electrical wires may extend within the channel. One of skill in the art of pull cord patient monitoring devices will recognize that there are a variety of ways in which the alarm may be activated, and the invention is not limited in this respect.

As shown in FIGS. 4-6, in one embodiment, tether 52 may be coupled to a top surface 24 of the warning system 20. However, the invention is not so limited. As shown in FIG. 7, in another embodiment, tether 52 is coupled to a side surface 26 of warning system 20. It should be appreciated that the tether may be coupled to any surface of the warning system.

Furthermore, tether 52 may be either permanently or removably coupled to warning system 20 as the invention is not so limited. For example, in one embodiment, tether 52 may be permanently coupled to warning system 20 (i.e. tether 52 is not readily removable from the warning system), such as with adhesive, interlocking components, or integrally formed components. In another embodiment, tether 52 may be removably coupled to the warning system, such as by way of one of the above-mentioned plug 56 and receptacle 58. However, it should be appreciated that in an embodiment where tether 52 is removably coupled to warning system 20, the force required to disconnect or decouple the connection between the tether 52 and the warning system 20 should be greater than the force required to decouple plug 56 from receptacle 58. In this respect, when the patient moves into a position that is outside of the boundaries designated by the monitoring device, the device should be configured such that plug 56 decouples from receptacle 58 to activate the alarm, rather than have the tether 52 decouple from the warning system 20 which may not activate the alarm.

Clip 30 may be any type of attachment device, as the invention is not limited in this respect. In one illustrative embodiment, clip 30 is similar to an alligator clip and it is configured to attach to the patient's clothing. It is contemplated that clip 30 may include one or more locking features to prevent the clip from detaching from the patient before plug 56 decouples from receptacle 58 (for example, either by the patient removing the clip and/or due to the clip sliding off of the patient's clothing). Other types of clips that may be used include any type of mechanical fastener, such as, but not limited to, a clothespin, a safety pin, a button, a snap, a hook and loop fastener, a strap or the like.

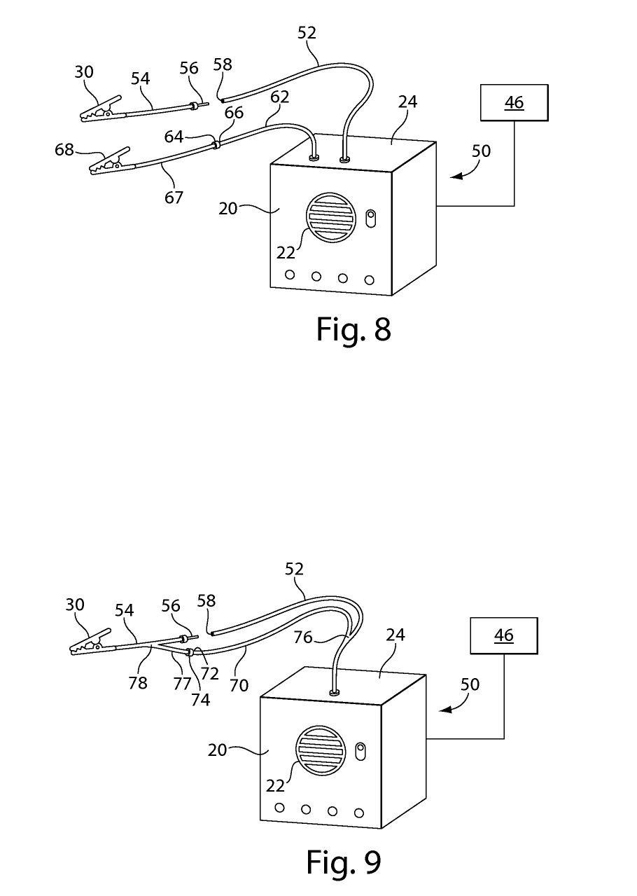

In other embodiments, as shown in FIGS. 8 and 9, a second tether may be provided. Referring now to FIG. 8, a second tether 62 may extend independently of tether 52 from warning system 20. A clip 68 may be attached to a cord 67 which may include a male plug 64. A female end/receptacle 66 is configured to receive plug 64 to removably couple the clip 68 to tether 62. In one embodiment, the combination of tether 62 and cord 67 may be longer than the combination of cord 54 and tether 52, so that when the patient first begins to move, plug 56 decouples from receptacle 58 before plug 64 decouples from receptacle 66. Only when the patient moves a greater distance does plug 64 decouple from receptacle 66. This could allow a staged alarm system. When plug 56 decouples from receptacle 58, a first alarm could be sounded. This alarm could be a gentle alarm, such as a flashing light, or a low decibel audio signal. When plug 64 decouples from receptacle 66, a louder signal, or a brighter light, or even a strobe light could be utilized to provide a signal providing a higher level of alert to the caregiver, or even to the patient who may be unaware of any danger that might befall him/her. In another embodiment, the combination of tether 62 and cord 67 may be about the same length as the combination of tether 52 and cord 54, but the force required to pull plug 64 from receptacle 66 is greater than the force required to pull plug 56 from receptacle 58. This result could be achieved by providing a tighter fit between plug 64 and receptacle 66 than the fit between plug 56 and receptacle 58. A tighter fit could be produced by making the outer diameter of plug 64 with respect to the inner diameter of receptacle 58 somewhat larger than the diameter of plug 56 with respect to receptacle 58. This result can also be achieved by providing a friction between plug 64 and receptacle 66 that is greater than the friction between plug 56 and receptacle 58, in a manner well known to those of skill in the art. More force would be required to separate plug 64 from receptacle 66 than would be required to separate plug 56 from receptacle 58.

In the embodiment of FIG. 9, tether 70 may extend from tether 52 at a location 76 spaced from warning system 20. In this embodiment, cord 77 could rejoin cord 54 at a location between plug 56 and clip 30. The electrical wiring in tether 70 and cord 77 would be independent of the electrical wiring in tether 52 and cord 54, but tether 70 could be bundled with tether 52 at location 76 as long as the wiring in each tether was insulated from the wiring in the other tether. Like the embodiment of FIG. 8, tether 70 and cord 77 together could have a length somewhat greater than that of tether 52 and cord 54 together to allow plug 56 to disengage from receptacle 58 prior to disengagement of plug 74 from receptacle 72. In an alternative embodiment, the fit between plug 74 and receptacle 72 could be tighter, or have a greater level of friction than that between plug 56 and receptacle 58 so that plug 74 is pulled from receptacle 72 at a time after plug 56 is pulled from receptacle 58 and only in response to greater movement by the patient. In yet another embodiment (not shown), tether 70 could join with tether 52 at point 76, but could be provided with its own clip at the end of cord 77 to be attached to the patient. It is also contemplated that more than two tethers, such as three or four tethers, could be provided having different lengths, or requiring different amounts of force to separate the plug from the receptacle to provide varying levels of urgency in the alarm produced.

Warning system 20 may be in the same room as the patient and is configured to provide an alarm to alert a caregiver when plug 56 is decoupled from receptacle 58 or when plugs 64 and 74 are decoupled from receptacles 66 and 72, respectively, to detect a change in the position and/or location of a patient. In another embodiment, the alarm may be produced at a remote site, such as a nurses station 44, either in addition to warning system 20 or instead of warning system 20. Warning system 20 may be configured to produce an auditory alarm and/or a visual alarm. In one embodiment, warning system 20 may include an auditory alarm which is produced by speaker 22. An auditory alarm may produce a beeping sound, a siren sound, an intermittent sound, or a continuous sound. The auditory alarm may also include other sounds to alert a caregiver, such as an automated voice recording, a chime, or a tone. A visual alarm may include a light which may either be flashing or steady. A visual alarm could also include a strobe light. In other embodiments, the visual and/or auditory alarms may include other types of known alarms featured in various conventional alarm systems. If warning system 20 includes both an auditory and a visual alarm, warning system 20 may be configured so that a caregiver can select the type of alarm which will be activated. Furthermore, warning system 20 may include different settings to adjust the volume and/or brightness of the alarm. For example, in one embodiment, where the alarm is an auditory alarm, the caregiver may be able to adjust the volume of the alarm between, for example, 100 dB and 90 dB. Varying levels of urgency could be provided such as by varying the loudness in an audible alarm or by varying the levels of brightness in a visual alarm. Different colors could also be used or a pulsing or strobe light could be employed to provide a greater sense of urgency in a visual alarm.

In another aspect, as shown in FIGS. 8 and 9, a light 46 may be activated when movement of a patient is detected. Light 46 may be activated either in addition to an alarm, or in place of the alarm. Light 46 provides illumination adjacent the patient, or in the room in which the patient is located, so that the patient may avoid injuring himself or herself as the patient moves from one location to another. In one embodiment, light 46 is used in conjunction with the embodiments of FIGS. 8 and 9, and is activated when plug 56 is separated from receptacle 58 but before plug 64 is separated from receptacle 66, or before plug 74 is separated from receptacle 72. In this way, a light 46 may be illuminated to assist the patient without setting off an alarm. In another embodiment, light 46 may be used in conjunction with an alarm. If the patient continues to move, light 46 remains illuminated, but as plug 64 is pulled from receptacle 66 or as plug 74 is pulled from receptacle 72, an alarm is set off indicating additional movement of the patient.

The patient monitoring device of the present invention may be either battery powered or powered by a standard AC current. The embodiments illustrated in FIGS. 4, 8 and 9 may be battery powered and may require batteries in warning system 20.

It should be appreciated that various embodiments may be formed with one or more of the above-described features. The above aspects and features may be employed in any suitable combination as the present invention is not limited in this respect. It should also be appreciated that the drawings illustrate various components and features which may be incorporated into various embodiments. For simplification, some of the drawings may illustrate more than one optional feature or component. However, the invention is not limited to the specific embodiments disclosed in the drawings. It should be recognized that the invention encompasses embodiments which may include only a portion of the components illustrated in any one drawing figure, and/or may also encompass embodiments combining components illustrated in multiple different drawing figures.

It should be understood that the foregoing description of various embodiments are intended merely to be illustrative thereof and that other embodiments, modifications, and equivalents of the invention are within the scope of the invention recited in the claims appended hereto.

What is claimed is:

1. A patient monitoring device for use with a patient and a caregiver, the patient monitoring device comprising:
a warning system configured to provide an alarm to indicate, to a caregiver, a change in the position of a patient;
a tether extending outwardly from the warning system;
a clip configured to be removably coupled to the tether and coupled to the patient, wherein the warning system is configured to activate the alarm when the clip is decoupled from the tether.

2. The patient monitoring device of claim 1, further comprising a cord extending from the clip, wherein the cord removably couples the clip to the tether.

3. The patient monitoring device of claim 2, wherein the cord has a male end, and wherein the tether has a female end configured to receive the male end of the cord.

4. The patient monitoring device of claim 1, wherein the tether is sufficiently flexible to allow it to bend to be at least substantially parallel to a surface of the warning system to which the tether is attached.

5. The patient monitoring device of claim 1, wherein the alarm is an audio alarm.

6. The patient monitoring device of claim 1, wherein the alarm is a visual alarm.

7. The patient monitoring device of claim 1, further comprising a sleeve extending around at least a portion of the tether.

8. The patient monitoring device of claim 1, wherein the tether includes a channel therethrough with a switch positioned within the channel, the switch configured to activate the alarm when the clip is decoupled from the tether.

9. The patient monitoring device of claim 1, wherein the tether is at least approximately one foot in length.

10. The patient monitoring device of claim 1, further comprising a light to illuminate an area around the patent when the clip is decoupled from the tether.

11. The patient monitoring device of claim 1, further comprising a second tether having a second clip removably coupled thereto, the second clip being configured to be removably coupled to the patient, the second clip being configured to decouple from the second tether to activate a second alarm only after the clip decouples from the tether as a result of patient movement.

12. The patient monitoring device of claim 1, further comprising a second tether removably coupled to the clip, the second tether being configured to decouple from the clip to activate a second alarm only after the tether decouples from the clip as a result of patient movement.

13. A patient monitoring device for use with a patient and a caregiver, the patient monitoring device comprising:
a warning system configured to provide an alarm to indicate, to a caregiver, a change in the position of a patient;
a clip configured to be non-magnetically removably coupled to the warning system and coupled to the patient, wherein the warning system is configured to activate the alarm when the clip is decoupled from the warning system; and
wherein the clip is flexibly connected to the warning system such that the clip may be decoupled from the warning system at a pull angle range of at least approximately 180 degrees.

14. The patient monitoring device of claim 13, wherein the clip is configured to be removably coupled to the warning system with a tether that extends outwardly from the warning system.

15. The patient monitoring device of claim 14, further comprising a cord extending from the clip, wherein the cord removably couples the clip to the tether.

16. The patient monitoring device of claim 15, wherein the cord has a male end, and wherein the tether has a female end configured to receive the male end of the cord.

17. The patient monitoring device of claim 14, wherein the tether is sufficiently flexible to allow it to bend to be at least substantially parallel to a surface of the warning system to which the tether is attached.

18. The patient monitoring device of claim 13, wherein the alarm is an audio alarm.

19. The patient monitoring device of claim 13, wherein the alarm is a visual alarm.

20. The patient monitoring device of claim 14, wherein the tether includes a channel therethrough with a switch positioned within the channel, the switch configured to activate the alarm when the clip is decoupled from the tether.

21. A method of monitoring a patient by a caregiver comprising the steps of:
attaching a clip of a patient monitoring device to a patient, wherein the patient monitoring device includes a warning system configured to provide an alarm, a tether extending outwardly from the warning system, and a clip configured to be removably coupled to the tether; and
activating the alarm when the clip is decoupled from the tether.

22. A patient monitoring device for use with a patient and a caregiver, the patient monitoring device comprising:
a warning system configured to provide an alarm to indicate, to a caregiver, a change in the position of a patient;
a first tether extending outwardly from the warning system at one end and being configured to be attached to a patient at another end, the first tether having associated therewith a first a receptacle into which a first plug is inserted, the first plug being pulled from the first receptacle when a certain force is applied thereto resulting from patient movement to activate the warning system with a first alarm;
a second tether extending outwardly from the warning system at one end and being configured to be attached to the patient at another end, the second tether having associated therewith a second receptacle into which a second plug is inserted, the second plug being pulled from the second receptacle upon continued patient movement to activate the warning system with a second alarm only after the first plug has been pulled from the first receptacle.

23. The patient monitoring device of claim 22, further comprising a first clip which is configured to be removably coupled to the patient and to be coupled to one of the first receptacle and the first plug.

24. The patient monitoring system of claim 23 further comprising a second clip, the second clip being configured to be removably coupled to the patient and to be coupled to one of the second plug and second receptacle.

25. The patient monitoring device of claim 23, wherein one of the second plug and the second receptacle is configured to be coupled to the first clip.

26. The patient monitoring device of claim 22, wherein the second tether is longer than the first tether.

27. The patient monitoring device of claim 22, wherein a greater force is required to pull the second plug from the second receptacle than is required to pull the first plug from the first receptacle.

28. The patient monitoring device of claim 22, further comprising a light for illuminating an area around the patient, the light being activated when the first plug is pulled from the first receptacle.
